(19) United States
(12) Patent Application Publication
(10) Pub. No.: US 2011/0223339 A1
(43) Pub. Date: Sep. 15, 2011

(54) METHOD FOR SURFACE PROCESSING

(75) Inventors: Yuichi Furukawa, Aichi-ken (JP); Fumio Kawahara, Aichi-ken (JP)

(73) Assignees: TOYOTA JIDOSHA KABUSHIKI KAISHA, Toyota-shi (JP); MEC INTERNATIONAL CO., LTD., Toyota-shi (JP)

(21) Appl. No.: 13/128,513

(22) PCT Filed: Dec. 8, 2009
(86) PCT No.: PCT/JP2009/070514

§ 371 Date: May 10, 2011

(30) Foreign Application Priority Data
Dec. 10, 2008 (JP) 2008-314991

(51) Int. Cl. B05D 1/36; B82Y 30/00; B82Y 40/00

(52) U.S. Cl. 427/402; 977/742; 977/734; 977/842; 977/958

(57) ABSTRACT

A method for a surface processing is provided. The method may include coating a surface of an object by a carbon coating including at least one type of a nano carbon selected from a carbon nano coil, a carbon nanotube and a carbon nano filament and applying liquid including fullerene to the carbon coating.

### TECHNICAL FIELD

The present application claims priority to Japanese Patent Application No. 2008-314991 filed on Dec. 10, 2008, the contents of which are hereby incorporated by reference into the present specification. The present application provides a technique for a method for surface processing in order to improve a surface characteristic (e.g., abrasion resistance, sliding characteristic and repellency) of an object.

### BACKGROUND ART

A method for surface processing that improves a surface characteristic (e.g. abrasion resistance, sliding characteristic, repellency) of an object by coating a surface of the object by a carbon coating that includes a nano carbon is known (e.g., Japanese Patent Application Publication No. 2008-105082).

Further, a technique is disclosed, in e.g. Japanese Patent Application Publication No. 2007-144499, for forming a carbon coating including fullerene as its principal component on a die surface of a die-casting die so as to inhibit the release resistance between the die and a molded product.

### SUMMARY OF INVENTION

### Technical Problem

The inventors of the present application invented a technique for coating a die surface by a carbon coating that includes at least one type of nano carbon selected from a carbon nano coil, a carbon nanotube and a carbon nano filament, and then applying fullerene. The details are taught in Japanese Patent Application No. 2008-198588. Although fullerene is effective in improving the surface characteristic, it has the defect of easily detaching from the die surface. However, according to the present invention, the detachment of fullerene from the die surface can be inhibited by capturing the fullerene with nano carbon extending in fiber shapes from the surface. It thus becomes unnecessary to re-apply fullerene frequently in order to maintain a good surface characteristic.

In case of applying fullerene to the surface of the carbon coating, fullerene powder may simply be applied directly to the surface of the object. However, the inventors found that a constant surface characteristic could not be obtained among a plurality of objects when applying fullerene powder directly to the respective objects. In addition, even in a case of re-applying fullerene so as to maintain the good surface characteristic over a long period, the surface characteristic differs before and after the re-application. That is, in the method of applying the fullerene powder directly, the surface characteristic varies among the respective applications. To address this, the inventors create a method where the object to undergo surface processing (called a “processed object” below) is heated once to approximately 300° C., then fullerene powder is applied onto a carbon coating formed on the surface of the processed object using a cloth to which fullerene powder has been applied. In this method, using the cloth to which sufficient fullerene powder has been applied, the fullerene powder is applied to the entire nano carbon coating surface while being equalized using a pressure of 250±50 kPa. Variation in the surface characteristic among processed objects is thereby reduced.

However, in the above method, the processed object must be heated once. Further, when the fullerene powder is applied, it must be equalized using a predetermined pressure. The technique taught in the present specification has been created taking the aforementioned circumstances into consideration. In the present specification, a method for surface processing in which fullerene is applied onto a coating including a nano carbon, which is a method for surface processing that may use a simple method to inhibit the variation in the surface characteristic occurring among the applications of fullerene is taught.

### Solution to Technical Problem

A method for surface processing of the technique taught in the present specification comprises coating a surface of an object by a carbon coating including at least one type of a nano carbon selected from a carbon nano coil, a carbon nanotube and a carbon nano filament and applying liquid including fullerene to the carbon coating.

In the above method for surface processing, fullerene spreads uniformly together with the liquid on the surface of the object. Therefore, the fullerene disperses uniformly on the surface of the object. Consequently, variation in the surface characteristic occurring among applications of fullerene can be inhibited. According to the method for surface processing of the technique disclosed in the present specification, it is not necessary to heat the processed object, nor is it necessary to equalize using a predetermined pressure.

The liquid applied in the second process may include alcohol. Fullerene disperses readily in alcohol. Consequently, a solution including fullerene can be manufactured easily. Further, at room temperature, the alcohol evaporates after having been applied and only the fullerene remains on the surface. Consequently, it is not necessary to wipe away the alcohol.

### Effect of Invention

According to the method for surface processing of the technique taught in the present specification, the variation in the surface characteristic occurring among applications can be inhibited using a simple method.

### BRIEF DESCRIPTION OF DRAWINGS

FIG. 1 shows a schematic view explaining a method for quantitatively assessing volatility.

FIG. 2 shows a process profile of a nano carbon coating forming process.

FIG. 3 shows an SEM image of a surface of a second specimen.

FIG. 4 shows an SEM image of a surface of a first comparative specimen.

### DESCRIPTION OF EMBODIMENT

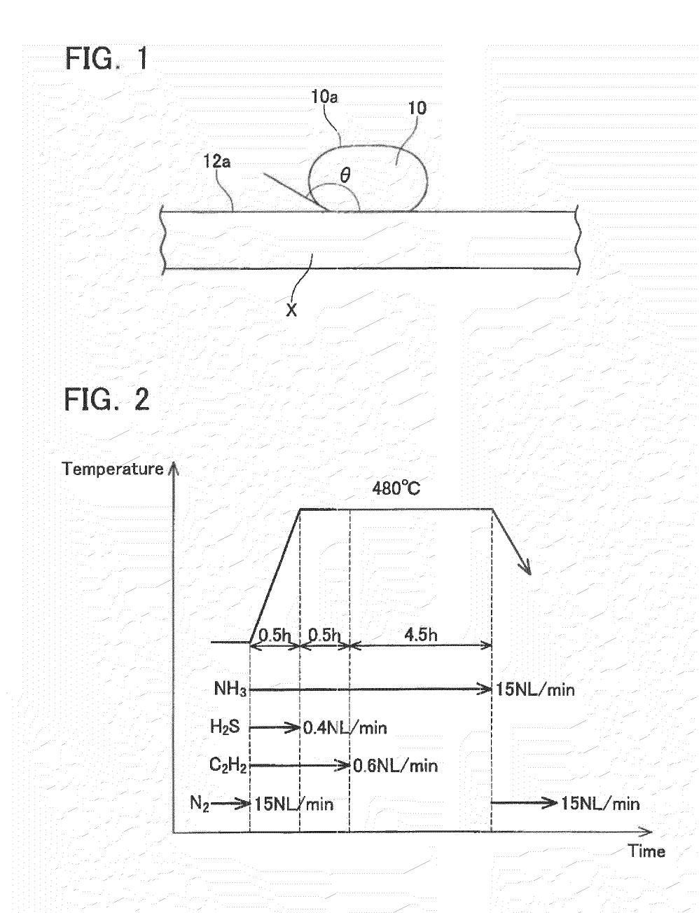

Experiments were conducted to determine the effectiveness of the method for surface processing of the technique taught in the present specification. Repellency was selected as an indicator of the surface characteristic obtained by the surface processing. In the experiments, the repellency was quantified using a measuring method below. As shown in FIG. 1, water droplets were dropped from above onto a specimen X that had undergone the surface processing, and an angle θ between a surface 12a of the specimen X and a surface 10a of water droplets 10 that had adhered to the surface of the specimen X was measured. Greater angle θ indicates higher repellency. The specimen X that is the target of surface processing is metal. Specifically, the specimen X is a plate manufactured from SKD 61 (alloy tool steel: JIS G4404). Five types of specimens: first to fifth specimens were prepared as the specimen X to which a liquid including fullerene has been applied. Further, first and second comparative specimens were prepared for comparison. Surface processing including the processes indicated below was performed on the surfaces of the first to fifth specimens and the first and second comparative specimens. Ten items were prepared for each of the first to fifth specimens and the first and second comparative specimens.

First process (nano carbon coating forming process): a nano carbon coating was formed on the surfaces of the first to fifth specimens and the first and second comparative specimens using the method described below. Further, the following method is disclosed in Japanese Patent Application Publication No. 2008-105082. This is a method for forming the carbon coating (nano carbon coating) including a nano carbon such as a carbon nano coil, a carbon nanotube, a carbon filament, etc. on the steel material manufactured from SKD 61.

The specimens were placed in an atmosphere furnace, air was purged using a vacuum pump, then nitrogen gas (N₂) was circulated to create an N₂ atmosphere in the atmosphere furnace. Next, in accordance with the process profile shown in FIG. 2, heating to 480° C. for 0.5 h was performed while reaction gas was circulated. Hydrogen sulfide (H₂S) gas, acetylene (C₂H₂) gas and ammonia (NH₃) gas were used in the reaction gas. After 0.5 h from a beginning of the heating, when 480° C. was reached, supply of the hydrogen sulfide gas was halted, then after a further 0.5 h, supply of the acetylene gas was halted. Further, the temperature was maintained at 480° C. for 4.5 h while the ammonia gas was circulated, then supply of the ammonia gas was halted, the supply of gas was switched to the nitrogen gas, and cooling was started. A nano carbon coating was formed on the respective surface of the specimens by the above processing. Furthermore, at this time, a nitride layer and a sulfurized layer were formed between the respective base material of the specimens and the nano carbon coating thereon.

Second process (fullerene application process): in the first specimens, alcohol (isopropyl alcohol in the present embodiment, called simply alcohol below) containing 1% fullerene by weight was applied using a brush to a respective surface of the first specimens on which the carbon coating had been formed. In the second to fourth specimens, alcohol containing respectively 5%, 10% and 30% fullerene by weight was applied using the brush to the respective surface on which the carbon coating had been formed. In the fifth specimens, alcohol containing 5% fullerene by weight was applied using a manual spray to a respective surface on which the carbon coating had been formed. The applications to the first to fifth specimens were all performed at room temperature.

In the first comparative specimens, fullerene powder was applied directly to a respective surface on which the carbon coating had been formed. More specifically, after the first comparative specimens were heated once to approximately 300° C., a cloth to which fullerene powder had been applied was pressed onto the respective surface of the first comparative specimens. The fullerene powder was thus applied onto the nano carbon coating formed on the respective surface of the processed objects. Furthermore, at this occasion, sufficient fullerene powder was applied to the cloth, and the fullerene powder was applied to the entire nano carbon coating surface while being equalized by a pressure of 250±50 kPa. Fullerene was not applied to the second comparative specimens.

Table 1 shows the experiment results. The numerical values in table 1 indicate the value of θ in FIG. 1.

TABLE 1

| | Applied | | | | | | | | | | |
|---|---|---|---|---|---|---|---|---|---|---|---|
| | Condition | | | | | | | | | | |
| | of | Specimen No. | | | | | | | | | |
| | Fullerene | 1 | 2 | 3 | 4 | 5 | 6 | 7 | 8 | 9 | 10 |
| First | Brush | 120 | 120 | 120 | 120 | 120 | 120 | 110 | 110 | 120 | 118 |
| Specimen | (1 wt %) | | | | | | | | | | |
| Second | Brush | 110 | 100 | 110 | 120 | 110 | 110 | 100 | 100 | 90 | 106 |
| Specimen | (5 wt %) | | | | | | | | | | |
| Third | Brush | 90 | 90 | 90 | 90 | 90 | 90 | 110 | 70 | 110 | 92 |
| Specimen | (10 wt % ) | | | | | | | | | | |
| Fourth | Brush | 90 | 90 | 90 | 100 | 70 | 40 | 90 | 20 | 20 | 68 |
| Specimen | (30 wt %) | | | | | | | | | | |
| Fifth | Spray | 120 | 40 | 100 | 100 | 80 | 80 | 90 | 80 | 80 | 86 |
| Specimen | (5 wt %) | | | | | | | | | | |
| First | Powder | 60 | 50 | 45 | 40 | 40 | 45 | 45 | 60 | 70 | 51 |
| Comparative | | | | | | | | | | | |
| Specimen | | | | | | | | | | | |
| Second | Not | 110 | 100 | 100 | 90 | 80 | 100 | 100 | 110 | 110 | 100 |
| Comparative | Applied | | | | | | | | | | |
| Specimen | | | | | | | | | | | |

Weight % in Parentheses Indicates Content of Fullerene
Numerical Value Indicates Angle (Unit: Degrees)

As shown in table 1, the respective variation in the repellency in the first to third specimens is substantially the same as or smaller than the variation in the first comparative specimens to which fullerene powder was applied. This variation was substantially the same as the variation of the second comparative specimens to which fullerene was not applied, i.e., where the carbon coating was formed. In particular, the variation was the smallest in the first specimens, in which the percentage of fullerene by weight was the smallest. The variation was greater in the fourth specimens than the other specimens. This was because the fullerene was not well dispersed in the alcohol in the fourth specimens due to there being a high percentage of fullerene by weight. When using alcohol having a high percentage of fullerene by weight, the variation can be inhibited by dispersing the fullerene well in the alcohol. Further, with the exception of the second piece of specimen, the variation was substantially the same in the fifth specimens as in those of the first to third specimens.

Further, as shown in table 1, the value of 0 was greater in the case of including fullerene in alcohol and applying the same than in the case of the first comparative specimens in which fullerene powder was applied. That is, the repellency of the surface was higher in the cases of including fullerene in alcohol and applying the same than in the cases of applying fullerene powder.

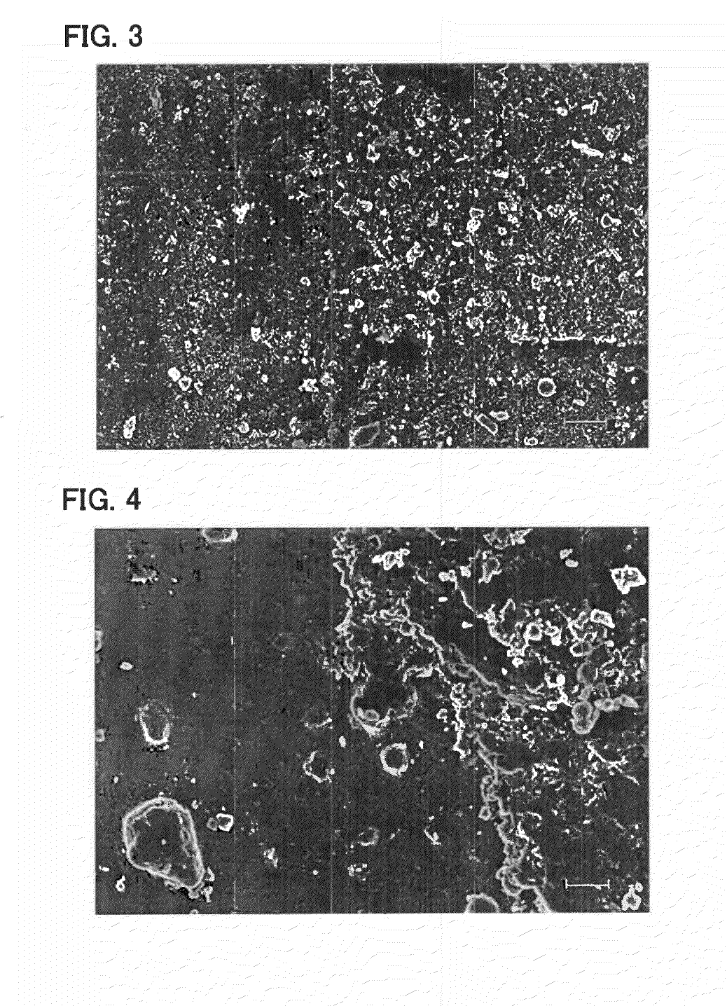

FIG. 3 shows an SEM image of the surface of one of the second specimen. FIG. 4 shows an SEM image of the surface of one of the first comparative specimen. Each of void lines in the lower right areas of FIGS. 3 and 4 indicates a length of 100 μm. In FIG. 3, irregularities are observed in the carbon coating formed by coating nano carbon on the surface of the specimen. On the other hand, there are few irregularities in the carbon coating in FIG. 4. It can be conjectured that the repellency is increased by the irregularities in the carbon coating on the surface to which the fullerene contained in alcohol was applied.

In the method for surface processing performed on the first to fifth specimens, the variation in the surface characteristic occurring between each application of fullerene can be reduced. In the above method for surface processing, the fullerene dispersed in the alcohol need merely be applied using the brush or spray. That is, it is not necessary to heat the processed object, nor is it necessary to equalize the processed object using a predetermined pressure. A smaller amount of fullerene can be used in the above method for surface processing than in the case of applying fullerene powder.

In the method for surface processing performed on the first to fifth specimens, alcohol was used as the liquid in which fullerene was included. In the above method for surface processing, isopropyl alcohol was used as the alcohol. However, in the method for surface processing taught in the present specification, other types of alcohol may be used as the liquid in which fullerene is included. Fullerene disperses easily in alcohol. Consequently, a solution including fullerene can be manufactured easily. Further, at room temperature, alcohol evaporates after application and only the fullerene remains on the surface. Consequently, it is not necessary to wipe away the alcohol. On the other hand, if the fullerene application process is performed in a high temperature environment, the alcohol evaporates before spreading sufficiently on the surface. Consequently, in a high temperature environment, a liquid having a lower volatility than alcohol may be used. The type of liquid in which the fullerene is included may be selected according to the temperature environment of the fullerene application. For example, a die immediately after casting has a comparatively hot temperature. In this case, a liquid in which an appropriate amount of surfactant has been mixed with water may be used as the liquid including fullerene. In this type of liquid, the liquid can be prevented from evaporating before having spread sufficiently on the surface, and applicability at high temperatures is also excellent.

In the above embodiment, two types of methods were adopted to apply the alcohol: application using the spray, and application using the brush. Using the brush rather than the spray allows scattering of the alcohol to be prevented and yield to be improved.

The below should be noted for the technique taught in the present specification. The carbon coating including at least one type of a nano carbon selected from the carbon nano coil, the carbon nanotube and the carbon nano filament, and the liquid including fullerene may each include substances other than carbon.

Fullerene is a carbon cluster having a closed shell structure, and normally has an even number of carbon atoms ranging from 60˜130. Specific examples are C₆₀, C₇₀, C₇₆, C₇₈, C₈₀, C₈₂, C₈₄, C₈₆, C₈₈, C₉₀, C₉₂, C₉₄, C₉₆ and higher-order carbon clusters having a greater number of carbon atoms. Apart from the above fullerenes, fullerene of the technique taught in the present specification includes fullerene derivatives wherein other molecules or functional groups have been chemically modified in the fullerene molecules. In the fullerene application process, liquid including substances other than fullerene may be applied to the object surface.

Some technical features of the embodiment are listed.

(1) In the application process (second process) for applying the liquid including fullerene to the surface, this application is preferably performed using a brush.
(2) The principal component of the liquid including fullerene is preferably alcohol.

Specific examples of the present invention are described above in detail, but these examples are merely illustrative and place no limitation on the scope of the patent claims. The technology described in the patent claims also encompasses various changes and modifications to the specific examples described above.

1. A method for a surface processing comprising:
coating a surface of an object by a carbon coating including at least one type of a nano carbon selected from a carbon nano coil, a carbon nanotube and a carbon nano filament; and
applying liquid including fullerene to the carbon coating.

2. The method for the surface processing as in claim 1 wherein, the liquid includes alcohol.

3. The method for the surface processing as in claim 2, wherein, the liquid of alcohol includes 1 to 10 wt % of fullerene.
